(19) United States
(12) Patent Application Publication
(10) Pub. No.: US 2023/0381626 A1
(43) Pub. Date: Nov. 30, 2023

(54) PHYSICAL TRAINING SYSTEM

(71) Applicants: Jacob GOERES, Phoenix, AZ (US); Tyler SCHNORF, Flagstaff, AZ (US)

(72) Inventors: Jacob GOERES, Phoenix, AZ (US); Tyler SCHNORF, Flagstaff, AZ (US)

(21) Appl. No.: 18/202,815

(22) Filed: May 26, 2023

Related U.S. Application Data
(60) Provisional application No. 63/346,598, filed on May 27, 2022.

(51) Int. Cl. A63B 71/06

(52) U.S. Cl. CPC A63B 71/0619; A63B 2214/00; A63B 2209/10; A63B 2071/0655

(57) ABSTRACT

A physical training system and method. This system includes a strap having a remotely controlled vibrating unit. The vibrating unit is designed to enhance motor learning and motor skill acquisition by increasing proprioceptive feedback during rehabilitation exercises or athletic training. The vibrating unit in the strap is controlled through a remote unit allowing for a portable, cordless training experience. The remote unit and the vibrating unit can be paired by matching the number combination of the switches located on the remote and vibrating units (via a DIP switch in both the remote and vibration unit). Depending on how long an actuation button is held down on the remote, vibration may be administered continuously or intermittently in relation to the desired movement during rehabilitation or athletic training.

### FIELD OF INVENTION

This concept relates to a physical training system useable by a trainer, such as an athletic trainer or a physical trainer, to encourage a human or an animal to properly perform certain motions.

### BACKGROUND

Proprioception is a term that applies to every muscle movement and without proprioception every individual movement would have to result from a direct thought.

Proprioception, otherwise known as kinesthesia, is the awareness or perception of the position, action, and movement of the body or parts (limbs) of the body. Proprioception is controlled primarily in the dorsal column and spinocervical tracts of the spinal cord which relay sensory information to the brain. This sensory information is then processed in the brain, resulting in a motor output. This proprioceptive feedback loop can be disrupted in numerous ways as a result of various events, including stroke, traumatic brain injury, spinal cord injury, or damage to peripheral nerves.

Physical therapists, occupational therapists, and athletic trainers are educated on the role of proprioception and the influence it has on movement mechanics. Electric muscle stimulation (typically administered via wired TENS units) is a traditional means used by rehabilitation personnel to train proprioception; however, this method comes with limitations. Electric stimulation works by exciting action potentials within the muscular unit to generate a muscle contraction. This process is effective at a muscular level, but there is current debate about how effective this method is on a neurological level because the muscle activation stimulated by the electric current is not always voluntary. A passive muscle contraction has shown to not be the most effective means of training motor skill acquisition and movement mechanics.

Another form of electric stimulation exists that involves voluntary muscle contraction and is referred to as Russian current. This form of electric stimulation is also used as a form of proprioceptive training. However, there is a primary difference in the timing of feedback of Russian current versus the concept being discussed below. With Russian current, the electric current is administered by the machine regardless of the user performing a voluntary muscle contraction. Russian current stimulation is used to improve or cause muscle contraction. Therefore, there is no known successful indication of completion of the task at hand by use of Russian current, except for the possible visualization of the muscle contracting.

### SUMMARY OF EMBODIMENTS OF THE INVENTION

An embodiment of the invention includes a vibrating motor mounted to a strap configured to be secured to a limb or other body part of the user or trainee. A remote unit is electronically coupled to the motor. The remote unit selectively energizes the vibrating motor when activated by the trainer. The vibrator can be activated continuously or intermittently.

A single remote unit can be remotely coupled to one or multiple vibrating units coupled to a plurality of trainees. Switches or switch combinations can be employed to provide activation signals from the remote unit to selected vibrating units.

### BRIEF DESCRIPTION OF THE DRAWING

The objects, advantages, and features of this system will be readily understood from the following detailed description, when read in conjunction with the accompanying drawing, in which:

FIG. 1 is a perspective view of a vibration unit worn by a trainee in accordance with an embodiment of the invention;

FIG. 2 is a perspective view of a DIP switch unit mounted in the vibration unit of FIG. 1;

FIG. 3 is a perspective view of an actuation or remote unit which is remotely coupled to the vibration unit of FIG. 1;

FIG. 4 is a perspective view of a strap and the vibration unit of FIG. 1 which is mounted on the strap;

FIG. 5 is a plan view of the strap of FIG. 4;

FIG. 6 is a partial phantom perspective view of some of the operating parts of the vibration unit;

FIG. 6A is a perspective view of a simple vibration motor shown in FIG. 6;

FIG. 7 is a plan view of the internal operating parts of the vibration unit;

FIG. 8 is a circuit diagram of the vibration unit of FIG. 7;

FIG. 9 is a pictorial representation of the remote unit of FIG. 3;

FIG. 10 is a pictorial representation of the remote unit of FIG. 8; and

FIG. 11 is a parts list for the apparatus of this concept.

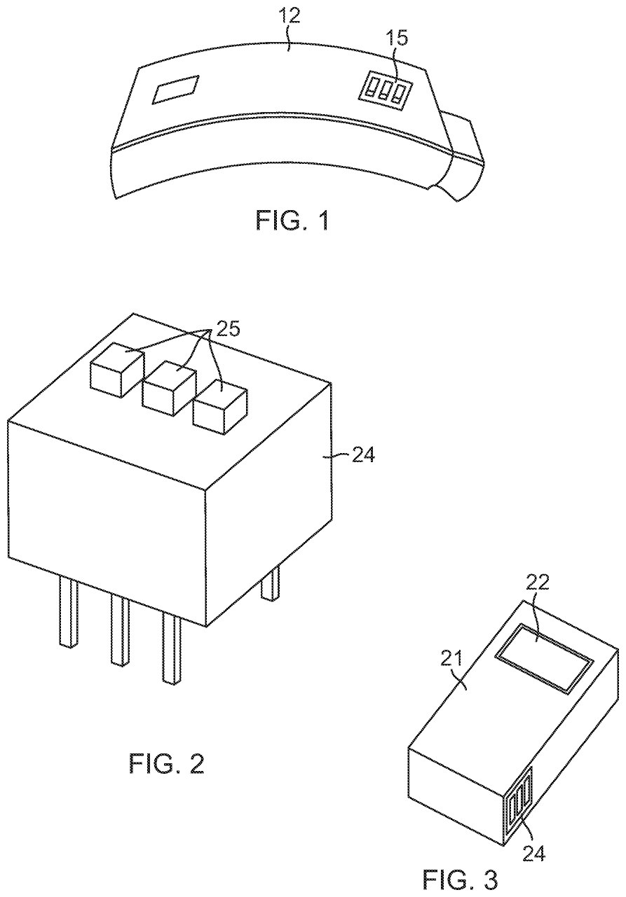

### DETAILED DESCRIPTION OF EMBODIMENTS OF THE INVENTION

### The Apparatus

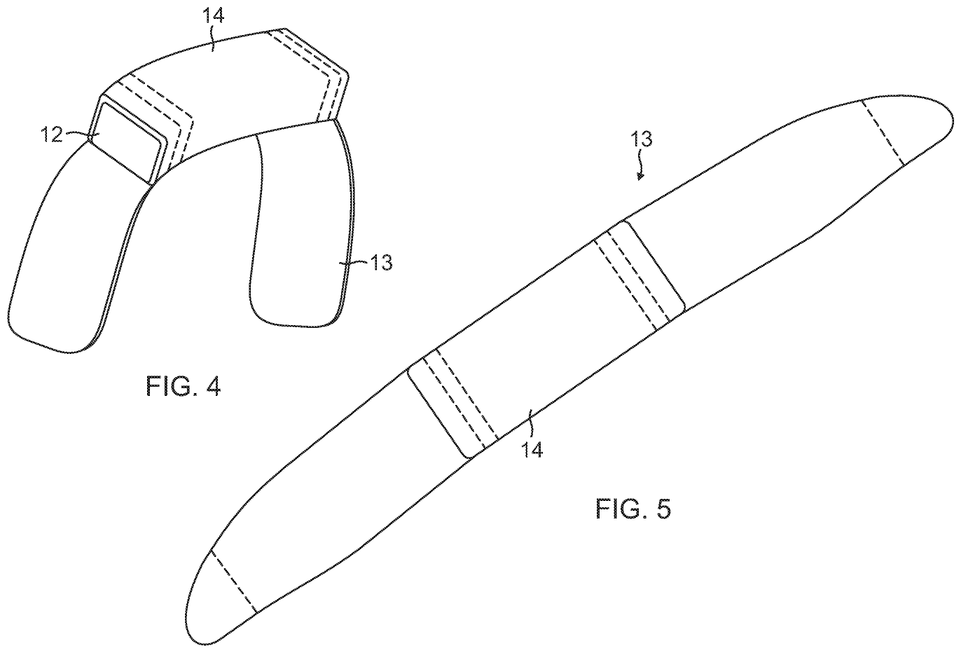

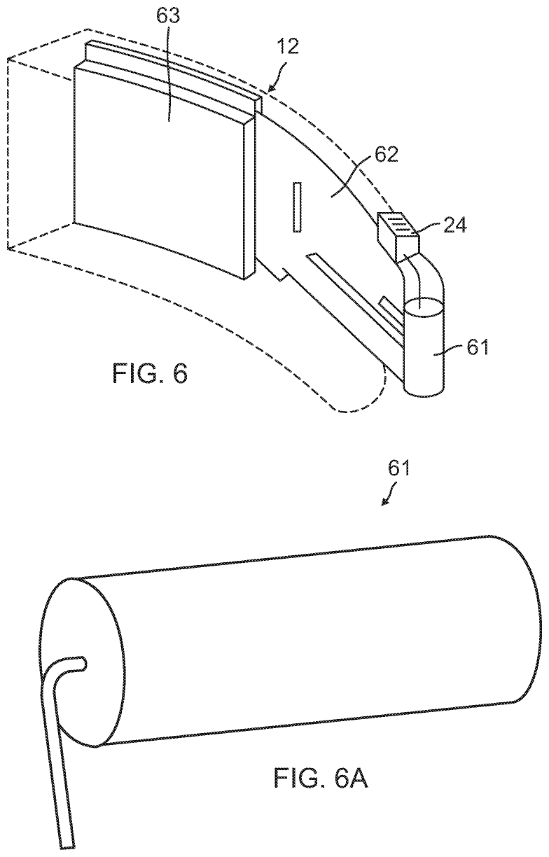

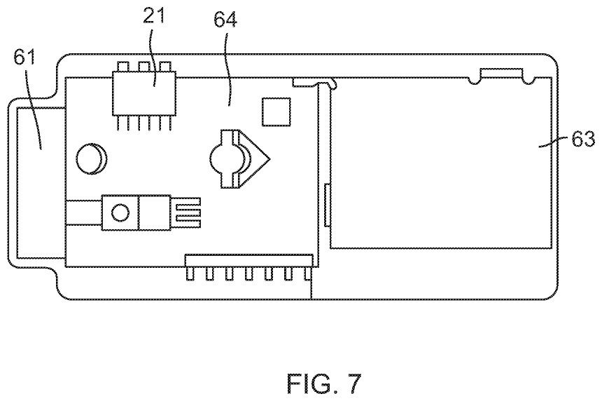

With reference now to the drawing, there is shown a vibrating motor 61 (FIGS. 6, 6A, and 7) coupled in vibration unit or device 12. As shown in FIGS. 4 and 5, strap 13 preferably includes a pocket 14 in which vibration unit 12 resides. The vibration unit is placed in the pocket when the training system is being readied for use with a user or trainee. As alternatives, vibration unit could be removably mounted to strap 13 by other means such as straps which could be buckled or otherwise secured around the vibration unit and strap 13, or by a direct hook-and-loop connection to the strap, for example.

Strap 13 preferably has an elastic characteristic, but elasticity is not required. One example of a suitable strap is a nylon laminated neoprene with hook-and-loop fasteners on the ends of the strap. Other materials that could function as strap 13 include elastics of several types and elasticities, webbing, leather, and other fabrics, natural or synthetic. Secure connection could also be by means of a belt buckle type or any other means for removably securing two ends of the strap together. The strap can be a unitary device, or it could be a laminate of appropriate materials.

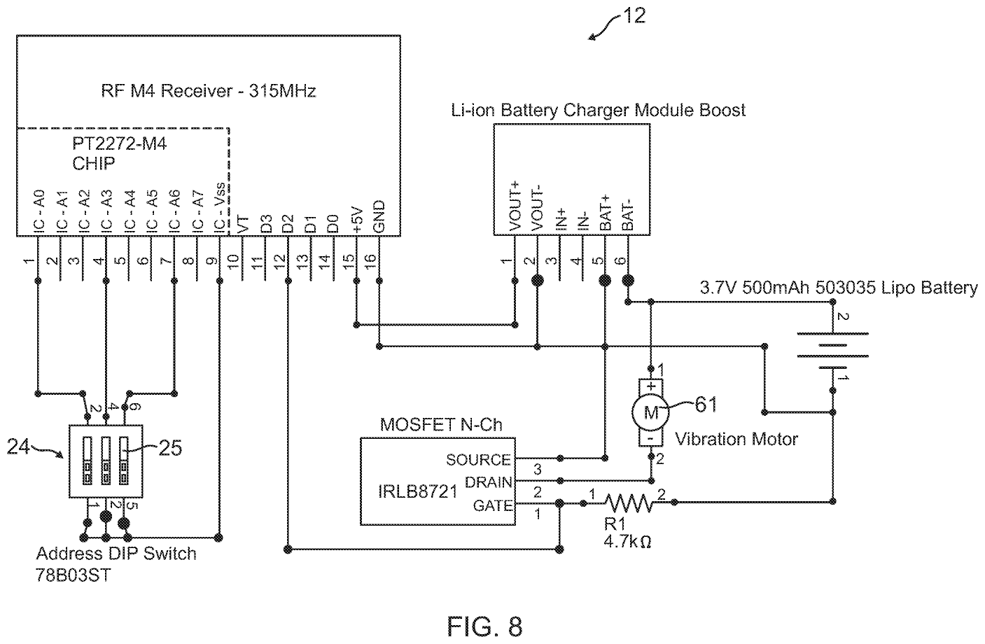

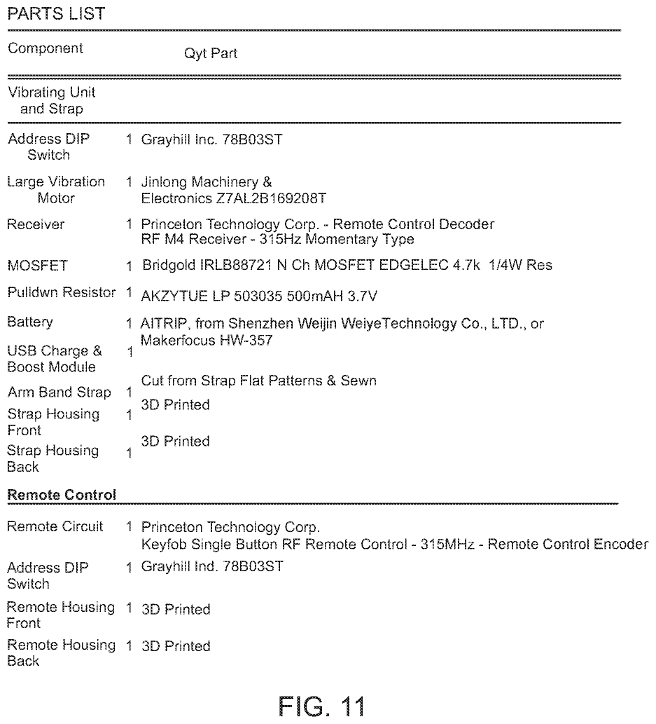

The circuit board and operating parts of vibration unit 12 are shown in FIG. 7 and its schematic representation is shown in FIG. 8. Vibration motor 61 can be a product of Jinlong Machinery of Electronics, as shown in FIG. 11. Acceptable such vibration motors are available from other manufacturers such as Nidec Corporation, Model: Nidec 12 mm Mini Vibration Motor, and Precision Microdrives, Model: PMDC-1020.

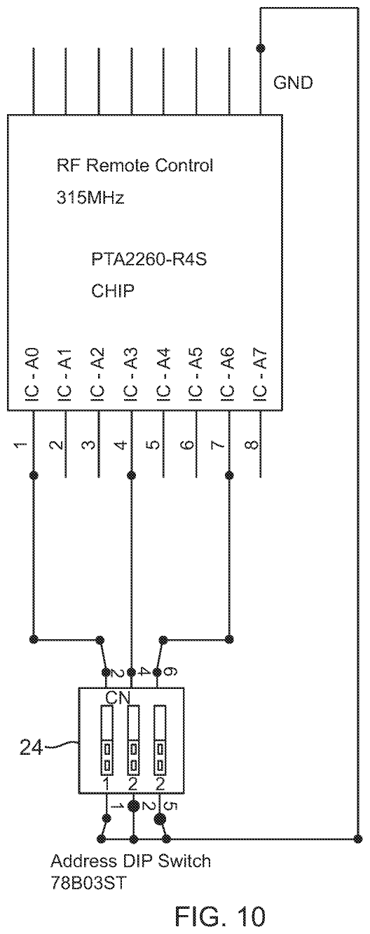

The remote circuit is shown in FIG. 10, and is identified in the list of parts as (FIG. 11) “Keyfob Single Button RF Remote Control.” This is sold by Princeton Technology Corp., Part No. PT2662, and is the Remote Control Encoder. With further reference to FIGS. 10 and 11, PT2262 is a remote-control encoder paired with PT2272 utilizing CMOS Technology. It encodes data and address pins into a serial coded waveform suitable for RF or IR modulation. PT2262 has a maximum of 12 bits of tri-state address pins providing up to 531,441 (or 312) address codes; thereby, drastically reducing any code collision and unauthorized code scanning possibilities.

Remote actuation unit 21 is shown in FIG. 3. On unit 21 is actuation button or switch 22. If configured to be used with multiple vibration devices the remote unit includes DIP switch unit 24, having separate switches 25, as shown in FIG. 2.

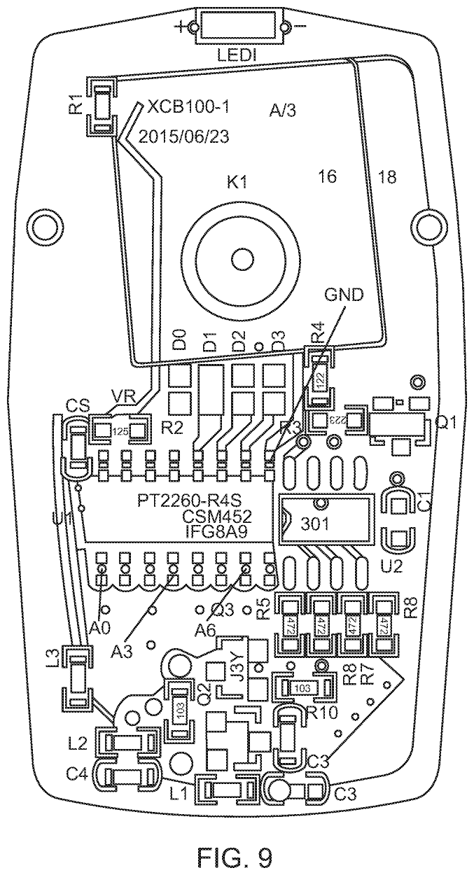

The circuit board for remote unit 21 is shown in FIG. 9 and its schematic representation is shown in FIG. 10.

The parts list for both vibration unit 12 and remote unit 21 is set out in FIG. 11.

Remote unit 21 is electronically coupled with the vibration unit in a well understood manner. When switch 22 is actuated, usually by pressing (it could be a rocker switch or any other type of on-off switch), the vibrating motor in unit 12 provides a tactile signal to the user. While it is preferable that switch 22 be spring loaded so that it actuates the vibrating motor momentarily, or as long as it is pressed or intentionally put into the “on” position, it need not be spring loaded.

When configured for the remote unit to work with more than one trainee and their individual vibration devices, the DIP switch unit on the remote unit may have multiple DIP switch buttons 25, there being three shown here. Each vibration device would also have DIP switches 25. Each vibration device 12 has its own code as set by the DIP switch 15 in known manner. When using three DIP switches, the remote unit's DIP switches can employ those switches with codes matching the code for each vibration device 12. This enables a trainer, with the remote unit, to work with three users, essentially simultaneously. Of course, there could be more than three DIP switches, but as a practical matter, a trainer can effectively work with three trainers.

While the term DIP switch is used here, any other type of switching system or structure can be used.

### The Method

In practice, a trainer chooses a strap 13 of appropriate length to fit the trainee's extremity being worked on. Typically, a longer strap will be employed for a user's leg or knee than for an arm. Of course, the strap length relates to the circumference of the target extremity and not to whether the extremity is a leg or an arm.

A vibrating motor is securely placed in pocket 14, or is otherwise removably secured to the strap, and the strap is secured around the user's extremity. Typically, the strap will include a hook-and-loop connecting means but other types of non-slip devices could be employed, even such as a belt buckle or arrangement. Once the strap is properly fitted, the rehabilitation personnel/trainer provides instruction to the user about the task, the body part position being trained and what constitutes successful completion of the task. During the task, the rehabilitation/training personnel observe the trainee's movement to determine if successful completion of the task is being, or has been, achieved. For example, if they are working on proper squat technique, the trainer will not cause vibration until the patient has squatted low enough or otherwise into the correct position. Once the patient has reached the correct position, the trainer will administer a momentary vibration, thus teaching the body through vibrational feedback that the correct movement has been achieved. The rehabilitation personnel/trainer may administer the vibration by pushing button 22 (FIG. 3) on the remote actuation unit continuously if the desired movement spans over a period of time, or intermittently if the desired movement occurs only momentarily. This process may occur over several repetitions of the same task, or throughout various tasks, depending on the goals of the training session.

The remote is held and operated by the rehabilitation personnel or athletic trainer who is responsible for determining what constitutes “desired mechanics.” The vibration is to be remotely administered during the periods of movement that qualify as desired movement mechanics. By only administering the vibration during desired performance by the user, motor learning can be most effective.

It should be noted that the present system is not intended to cause movement of any body part. All movements by the user or trainee are voluntary and intentional. The training aspect results from a remotely generated signal applied to the vibrating motor as a tactile sensory feedback when the trainer perceives that the subject has performed the assigned or instructed movement correctly.

For example, if a position, such as a lift, is to be held for five seconds, the user will not receive any vibration until the proper position is achieved and held for the target time. When the instructed position is initially achieved, the trainer will press the actuation switch and hold it for up to five seconds, or as long as the desired position is maintained for the assigned time duration.

Similarly, if a position is to be achieved only momentarily, a short burst will be applied to the vibration unit. If the movement positions are to be repeated, a vibration signal will be felt, as initiated by the trainer, only when the position is properly performed or achieved for each repetition. The user will know, from the vibrations applied, if only some of the repetitive positions are properly performed and some are not.

It can be appreciated that once the trainer has instructed the user or patient as to the proper position to be achieved, the user will know from feeling the vibrations when the desired movement is properly performed.

This system enables a trainer to work with up to three (when using a three-DIP-switch unit) trainees at the same time. This enables the trainer to be fully effective with each trainee and more efficient by working with more than one at a time. Actually, the system can be used with more than three trainees, only the switch codes need to be expanded.

Focal or segmental vibration can be an effective means of retraining proprioception. Because sensory information about vibration and proprioception are transmitted to the brain via the same dorsal column pathway of the spinal cord, focal vibration can effectively stimulate the desired area of the spinal cord and therefore enhance proprioceptive training.

What is claimed is:

1. A physical training system for at least one human or animal trainee, the system comprising:
a strap securable around an extremity of a trainee;
a selectively controllable vibration unit removably mountable to said strap;
a remote unit configured to selectively emit signals to actuate said vibration unit;
at least one switch on said remote unit; and
a receiver on said vibration unit which, in response to closing said switch on said remote unit, is activated to cause said vibration unit to vibrate.

2. The physical training system of claim 1, wherein:
said strap comprises a plurality of straps adapted to be secured to a plurality of trainees;
a like plurality of vibrating units, one of said vibrating units being removably mounted to each said strap; and
said at least one switch comprises a plurality of switches, each being separately paired with one said motor.

3. The system of claim 1, wherein said strap is formed with elastic characteristics.

4. The system of claim 1, wherein said strap is formed of nylon laminated neoprene.

5. The system of claim 1, wherein said strap is secured around the extremity of the trainee with a hook-and-loop fastener.

6. The system of claim 1, wherein said strap is secured around the extremity of the trainee with a buckle type of connection.

7. The system of claim 1, wherein said vibration unit includes a vibration motor.

8. A method for training at least one human or animal trainee, the method comprising:
mounting a vibrating motor to a strap;
applying the strap to the trainee in a removable manner;
selectively energizing a switch on a remote control unit to selectively activate the motor when the trainee achieves a position or an exercise as instructed.

9. The method of claim 8, wherein said at least one trainee comprises a plurality of trainees, the method further comprising:
choosing one of a plurality of switches on the remote control unit to activate one of the motors applied to one of a plurality of trainees.

10. The method of claim 8, wherein the vibrating motor is part of receiving circuitry that actuates a vibrating motor unit.
